(19) United States
(12) Patent Application Publication
(10) Pub. No.: US 2014/0173618 A1
(43) Pub. Date: Jun. 19, 2014

(54) SYSTEM AND METHOD FOR MANAGEMENT OF BIG DATA SETS

(71) Applicant: XPLENTY LTD., Tel Aviv-Yafo (IL)

(72) Inventors: Saggi NEUMAN, Tel Aviv-Yafo (IL); Moty MICHAELY, Modiin (IL); Yaniv MOR, Aviel (IL)

(73) Assignee: XPLENTY LTD., Tel Aviv-Yafo (IL)

(21) Appl. No.: 14/052,785

(22) Filed: Oct. 14, 2013

Related U.S. Application Data
(60) Provisional application No. 61/713,541, filed on Oct. 14, 2012.

(51) Int. Cl. G06F 9/50

(52) U.S. Cl. CPC G06F 9/5055
USPC 718/104

(57) ABSTRACT

A system and method for predicting the amount of time and/or resources required to execute a job on a big data set, and/or a system and method for automatically providing one or more suitable commands to a user for constructing a job for manipulating a big data set. The system and method are optionally and preferably implemented with regard to Hadoop.

### FIELD OF THE INVENTION

The present invention is of a system and method for managing big data sets, and in particular but not exclusively, to such a system and method for supporting job construction and job execution for big data sets.

### BACKGROUND OF THE INVENTION

Big data sets are becoming increasingly prevalent and their analysis is becoming increasingly important, even for small businesses—particularly as cloud computing becomes more widely available. Big data sets are prevalent for example in consumer markets, as web marketers can collect large amounts of data about everything that consumers are viewing and purchasing on the web. However, big data sets of many other types are being collected, including for example Twitter and other social media feeds, satellite data, digital videos and electric meter transmissions, thereby enabling companies to optimize, predict and plan in ways that were inconceivable a few years ago.

Various types of data infrastructures are available for analyzing big data sets, including for example Hadoop. Hadoop is a powerful, open source framework that supports storage and distributed processing of large amounts of diverse data on commodity hardware, such that it enables distributed processing of large data sets across clusters of servers. It is designed to be extremely scalable and fault-tolerant. Yahoo is the largest contributor to the Hadoop open source project. Hadoop also underpins Facebook, Twitter, eBay, and dozens of other high-profile web companies. Hadoop is very fast, fault-tolerant and efficient, but it is also difficult to deploy and use. From setup through data analysis and management, it requires a highly specialized skill set that is beyond the reach of most organizations.

Various solutions have been proposed to the problem of handling big data, but unfortunately many of these solutions—including Hadoop itself—are too difficult for most companies and organizations to operate. There are currently no simple solutions to the problem of big data.

### SUMMARY OF AT LEAST SOME ASPECTS OF THE INVENTION

The background art does not teach or suggest a system and method for predicting the amount of time and/or resources required to execute a job on a big data set. The background art also does not teach or suggest a system and method for automatically providing one or more suitable commands to a user for constructing a job for manipulating a big data set. The background art also does not teach or suggest such a system or method which is suitable for Hadoop.

The present invention overcomes these drawbacks of the background art by providing, in at least some embodiments, a system and method for predicting the amount of time and/or resources required to execute a job on a big data set. According to at least some embodiments, there is provided a system and method for automatically providing one or more suitable commands to a user for constructing a job for manipulating a big data set. According to at least some embodiments, the system and method are optionally and preferably implemented with regard to Hadoop, including any suitable implementations thereof, such as Hortonworks Data Platform (HDP) or CDH (Cloudera distribution of Hadoop).

As used herein, the term “data manipulation” also refers to data processing. The term “job” refers to one or more commands to be executed on a data set.

According to at least some embodiments of the present invention, there is provided a method for predicting at least one of execution time or execution resources required for executing a data job, the data job comprising at least one data manipulation command on a data set, the method being performed by a computer, the method comprising:

Providing a data cluster for executing the data job, said data cluster comprising computer hardware and a data infrastructure for performing said at least one data manipulation command with said computer hardware;

Extracting sample data from the data set;

Constructing a sample data cluster according to said sample data and said at least one data manipulation command;

Executing said at least one data manipulation command on said sample data with said sample data cluster;

Analyzing execution time required for executing said at least one data manipulation command on said sample data; and

Determining at least one of execution time or execution resources required for executing the data job according to said execution time for said sample data.

Optionally the method further comprises receiving the data job through a user interface application and for communicating said at least one of execution time or execution resources required for executing the data job to said user interface application.

Optionally the method further comprises requesting a change in execution resources to be applied to the data job through said user interface application; reconstructing said sample data cluster; re-executing said at least one data manipulation command on said sample data; analyzing said new execution time; determining at least one of a new execution time or new execution resources required; and communicating said at least one of execution time or execution resources required for executing the data job to said user interface application.

Optionally the method further comprises obtaining the data job by: providing a job design canvas through said user interface application; and determining a plurality of data manipulation commands and the data set through said job design canvas.

Optionally said determining said plurality of data manipulation commands further comprises: selecting a plurality of choices of data manipulation commands from a components repository according to at least one functional constraint and according to at least one user profile constraint; and displaying said plurality of choices of data manipulation through said job design canvas.

Optionally said at least one user profile constraint is determined according to permitted resources determined by a user profile.

Optionally said at least one functional constraint is determined according to said data infrastructure.

Optionally said selecting said choices and displaying said choices are sufficient to construct a set of commands for data manipulation, without the user writing code.

Optionally said selecting said plurality of choices further comprises only displaying choices of commands that are possible to execute within constraints of said data infrastructure.

Optionally the method further comprises a logic engine, wherein said logic engine determines which choices of commands are permissible to display.

Optionally the method further comprises providing an add-on management service for providing at least one additional resource for executing the job.

Optionally the method further comprises establishing compensation for said at least one additional resource through said user interface application, wherein said at least one additional resource comprises at least one of a changed data cluster or an additional data set.

Optionally said data infrastructure comprises Hadoop.

Optionally the method further comprises sending a command to execute the job through said user interface; transmitting a message to a cluster management service to initiate allocation of one or more clusters to the job; allocating said one or more clusters by said cluster management service; transmitting a message to a job management service to build job information for executing the job; building said job information by said job management service; and executing the job on said one or more clusters.

Optionally the method further comprises monitoring execution of the job by said job management service.

Optionally said one or more clusters are provided by one of a plurality of cloud providers, the method further comprising: selecting a cloud provider for providing said one or more clusters according to one or both of said execution resources and said execution time.

According to at least some embodiments, there is provided a system for predicting at least one of execution time or execution resources required for executing a data job, the data job comprising at least one data manipulation command on a data set, the system comprising:

A data cluster for executing the data job, said data cluster comprising computer hardware and a data infrastructure for performing said at least one data manipulation command with said computer hardware;

A cluster management service for constructing a sample data cluster; and

A prediction engine for extracting sample data from the data set, for causing said at least one data manipulation command to be executed on said sample data with said sample data cluster, for analyzing execution time required for executing said at least one data manipulation command on said sample data and for predicting at least one of execution time or execution resources required for executing the data job according to said execution time for said sample data.

Optionally the system further comprises a job management service for managing execution of the job on said data cluster according to said data infrastructure, and for managing execution of said at least one data manipulation command to be executed on said sample data with said sample data cluster.

Optionally the system further comprises a user interface application for communicating with a user, said user interface application receiving parameters of the job and transmitting said parameters to said prediction engine.

Optionally said user interface application receives said at least one of execution time or execution resources required from said prediction engine and requests additional execution resources from said prediction engine.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, including, but not limited to, a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, any type of mobile device, a PDA (personal digital assistant), a pager, or a tablet. Any two or more of such devices in communication with each other may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 relates to a non-limiting, illustrative, example of a system according to at least some embodiments of the present invention;

FIG. 2 shows a more detailed description of an exemplary, illustrative, non-limiting implementation of prediction engine 110 according to at least some embodiments of the present invention;

FIG. 3 shows an exemplary, non-limiting flow of operations involving prediction engine 110 according to at least some embodiments of the present invention;

FIG. 4 is a flow chart of an exemplary, illustrative, non-limiting method for interactions between the user, through the user application, and the prediction engine, including parts 1, 2 and 3, which have been so marked in the corresponding Figures;

FIG. 5A shows an exemplary system and FIG. 5B shows an exemplary flow process according to at least some embodiments of the present invention for providing a cluster management service over a Hadoop infrastructure, while FIG. 5C describes the flow for cluster repair according to an exemplary non-limiting method thereof;

FIG. 6A shows an exemplary system and FIG. 6B shows an exemplary flow process according to at least some embodiments of the present invention for providing a job management service over a Hadoop infrastructure;

FIG. 7 shows an exemplary, schematic block logic diagram for the API according to at least some embodiments of the present invention;

FIG. 8 shows an exemplary, non-limiting, illustrative schematic block logic diagram for the package designer in greater detail according to at least some embodiments of the present invention;

FIGS. 9A and 9B show exemplary, illustrative, non-limiting screenshots of a user profile-oriented toolbox menu;

FIG. 10 shows an exemplary, illustrative non-limiting method according to at least some embodiments of the present invention for cluster provision and management across a plurality of cloud providers; and

FIG. 11 shows an exemplary illustrative multi-tenancy architecture system according to at least some embodiments of the present invention.

### DESCRIPTION OF THE PREFERRED EMBODIMENTS

The present invention is, in at least some embodiments, of a system and method for predicting the amount of time and/or resources required to execute a job on a big data set. According to at least some embodiments, there is provided a system and method for automatically providing one or more suitable commands to a user for constructing a job for manipulating a big data set. As used herein, the term “data manipulation” also refers to data processing.

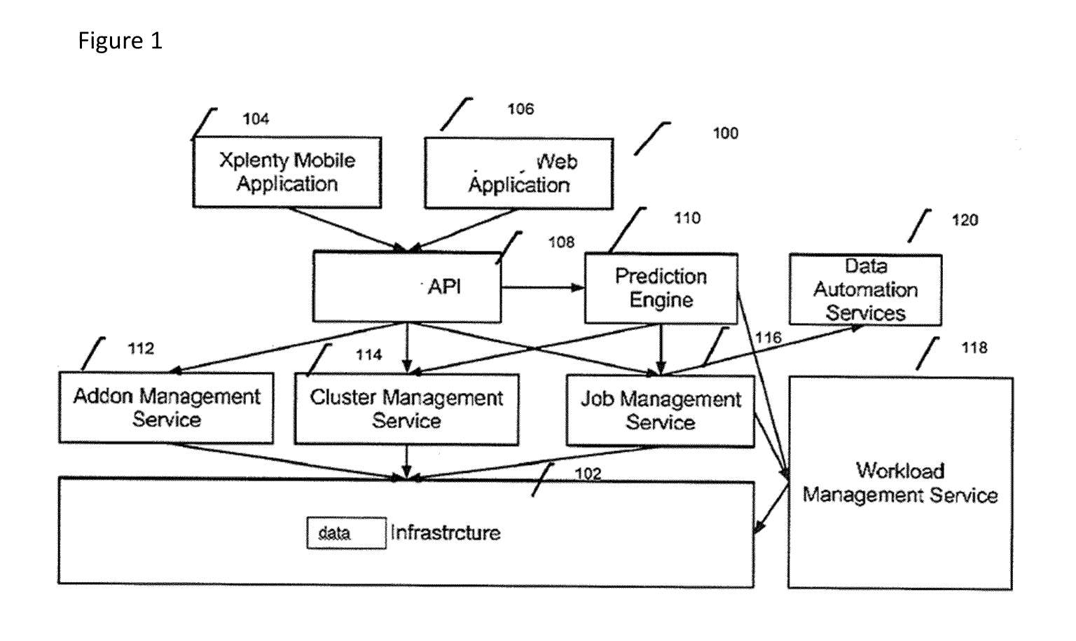

Turning now to the drawings, FIG. 1 relates to a non-limiting, illustrative, example of a system according to at least some embodiments of the present invention. As shown, a system 100 features a plurality of different components, which support the operation of at least some embodiments of the methods of the present invention. As FIG. 1 is a schematic block logic diagram, some components may optionally be combined and/or may optionally be implemented as a plurality of components. Furthermore, different implementations of system 100 are possible, such that FIG. 1 should not be understood to be limiting in any way. In any case, each of the components of system 100 may optionally be implemented as hardware, software or a combination thereof. Although not shown explicitly, computer network or other communication infrastructure is also preferably present to enable the components to communicate.

System 100 features a data infrastructure 102. Such a data infrastructure 102 may optionally be implemented according to any suitable art known system, including but not limited to any suitable off the shelf system, such as Hadoop for example; as well as any other big data system, including but not limited to Riak and Cassandra. Although some aspects of some embodiments of the present invention are described with regard to Hadoop, this is for the purposes of clarity only and is not intended to be limiting in any way. Although data infrastructure 102 is shown as a single component, optionally it may be implemented as a plurality of components, for example across a plurality of servers or virtual machines. Regardless of the exact infrastructure provided, preferably any suitable implementation for data infrastructure 102 includes at least the ability to handle exponentially large data sets.

For ease of user access to system 100, preferably at least one user interface application. For the purpose of illustration only and without any intention of being limiting, system 100 is shown as featuring two such interface applications: a mobile application 104 and a web application 106. Mobile application 104 enables the user to interact with system 100 through a mobile communication device (not shown), which operates mobile application 104. Web application 106 enables the user to interact with system 100 through a web-enabled communication device (not shown), which operates web application 106. By “web-enabled” it is meant that the communication device is capable of communicating with a computer network (not shown) such as the Internet for example, according to the HTTP protocol. Non-limiting examples of such communication devices include any type of computer, cellular telephone, wireless or wired smart telephone, or indeed any type of suitable computational device.

Regardless of whether the user communicates through mobile application 104 or web application 106, the user interacts with one of these applications to access the functions of system 100, through an API (application programming interface) 108. API 108 may also optionally be used to permit functionality of the previously described user interface applications to be embedded in other types of software interfaces (not shown). API 108 provides a central “gateway” for communication with the user interfaces, if necessary also including protocol translation.

API 108 receives one or more commands from the user through the user interface for performing one or more data manipulation commands, for example optionally according to a provided user toolbox (not shown; described below). API 108 then communicates with a prediction engine 110 to predict one or more characteristics of the data manipulation commands, for example including but not limited to one or more of data manipulation resources required, time required to perform the commands and so forth. Prediction engine 110 in turn communicates its findings to various other components as described in greater detail below.

In addition to interacting with the user interface, API 108 also optionally and preferably manages one or more of the overall system, data infrastructure, system monitoring, user activities through the system, clusters (for example, provisioning, managing and scaling), job scheduling and monitoring. As used herein, the term “cluster” refers to a cluster of hardware units for data processing, such as a cluster of servers for example; the cluster of hardware units may optionally comprise virtual elements also (such that a single hardware unit may optionally support multiple processors). Optionally and more preferably, API 108 handles all of these functions, thereby supporting and managing the functions of system 100. The components of API 108 and exemplary implementations are described in greater detail below.

In addition to prediction engine 110, API 108 also optionally and preferably communicates with an add-on management service 112, a cluster management service 114 and a job management service 116. These components in turn communicate with data infrastructure 102.

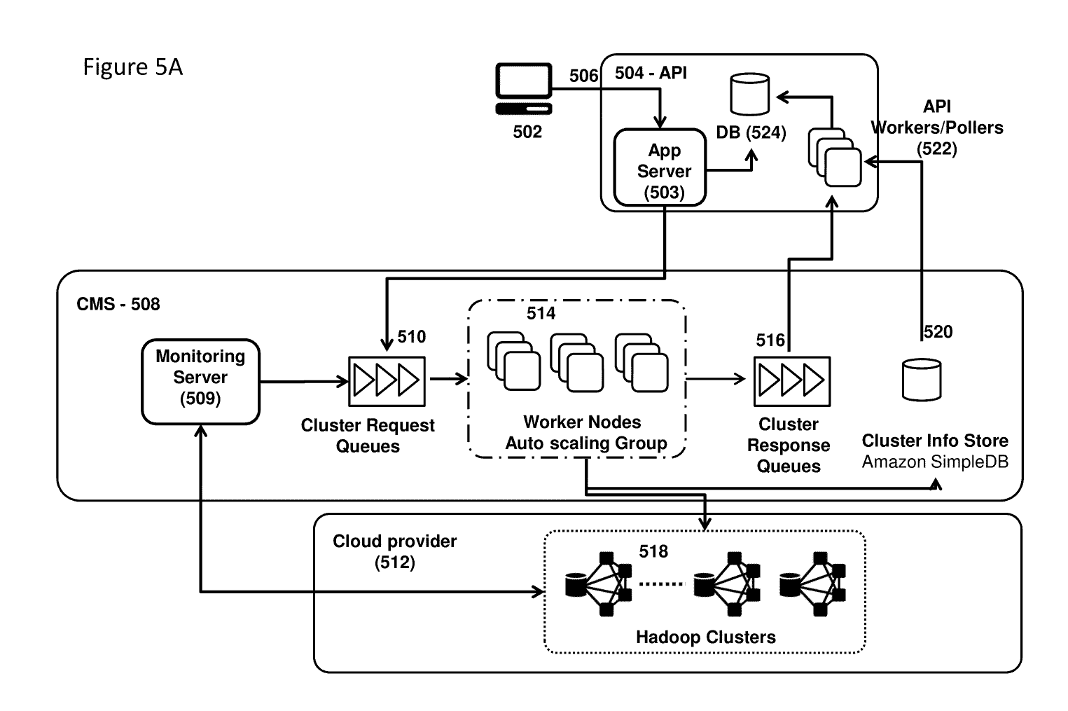

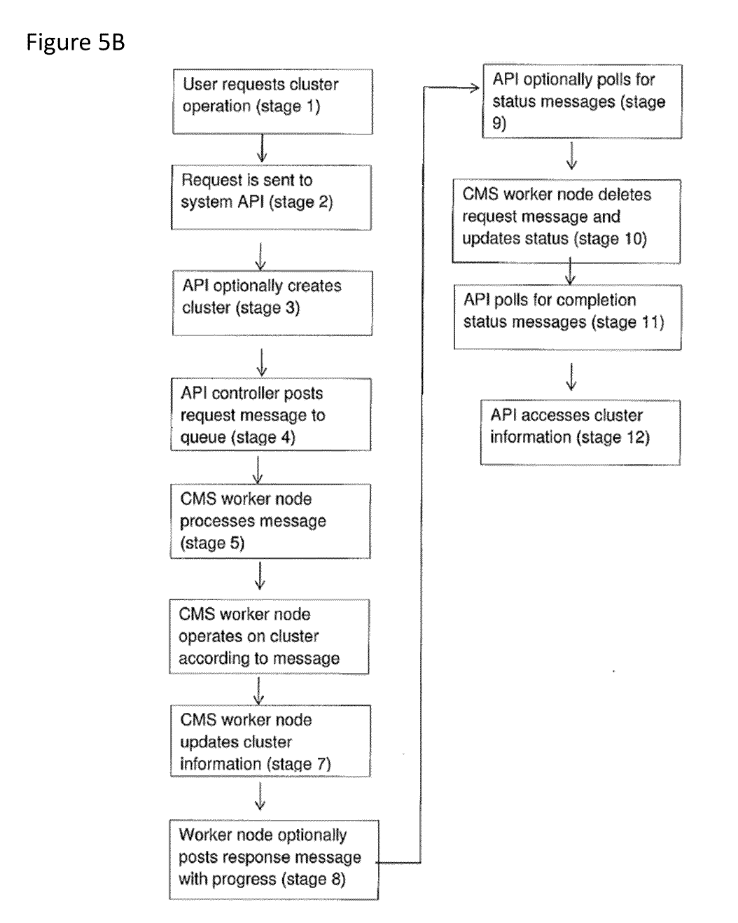

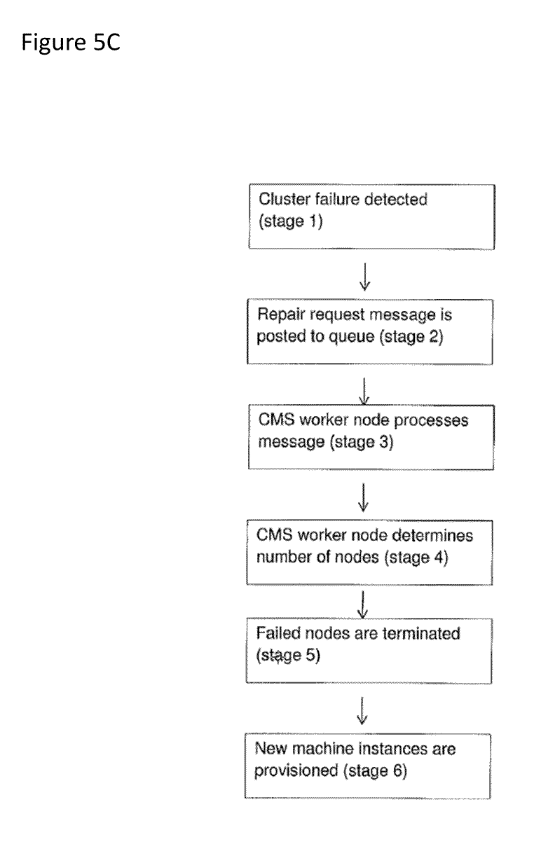

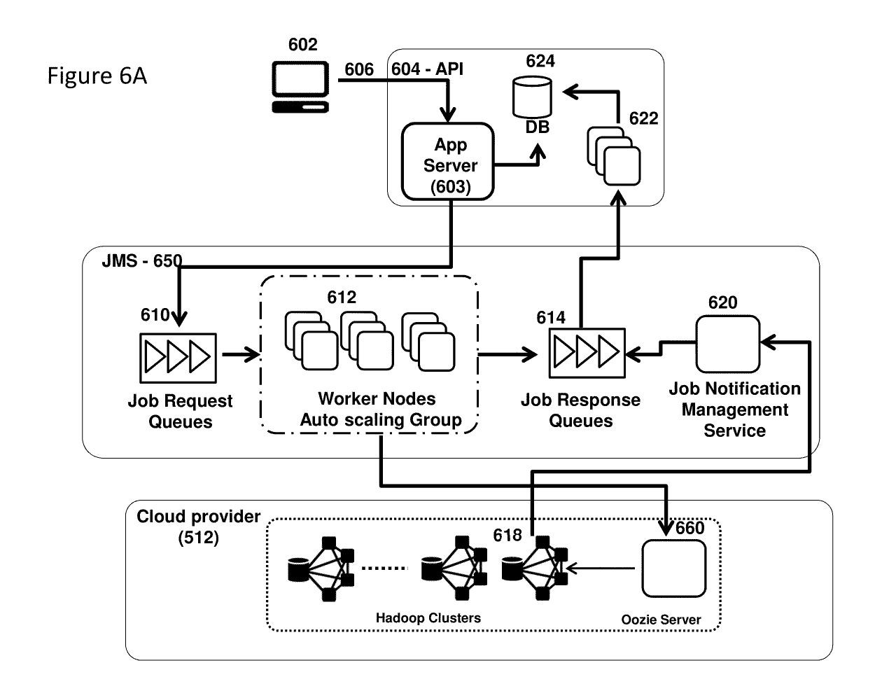

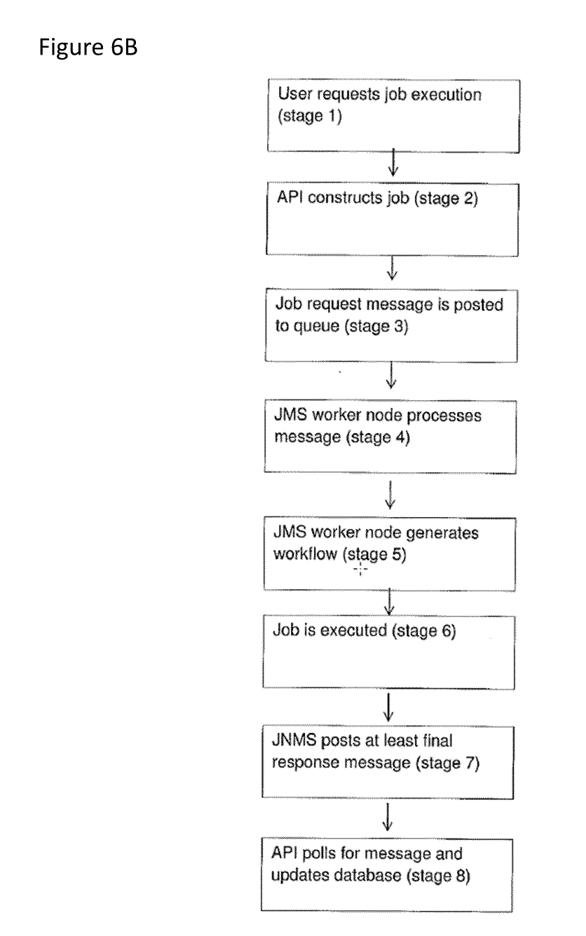

The functions of cluster management service 114 and job management service 116 are described in greater detail below with regard to FIGS. 5 and 6.

Add-on management service 112 optionally and preferably provides “add-ons” or additions to cluster functionality. Such additions may optionally include but are not limited to one or more of tools, configurations, additional components of system 100 and data. For example and without limitation, a configuration may optionally be provided by add-on management service 112 by rearranging a cluster or by bringing data automatically for storage, even without a job. Non-limiting examples of tools include scripts and software packages that are not provided through data infrastructure 102.

With regard to data, add-on management service 112 preferably enables data to be added automatically from another source, although the data is more preferably provided through a separate element of system 100, such as a data automation service 120, as described in greater detail below. With regard to additional components of system 100, prediction engine 110 may optionally be provided as such an addition, such that the user needs to indicate the choice to pay for this service before it is invoked.

Turning back to prediction engine 110, prediction engine 110 also optionally communicates with cluster management service 114 and job management service 116. Prediction engine 110 communicates with cluster management service 114 in order to provide information regarding one or more characteristics of the data manipulation commands to be performed, so that cluster management service 114 can set aside the necessary resources for at least the predicted amount of time. It should be noted that optionally multiple users, including multiple organizations, may share a particular cluster or clusters. Prediction engine 110 communicates with job management service 116 to provide such information regarding data manipulation commands (job) as job management service 116 manages each individual job.

Furthermore, prediction engine 110 and job management service 116 optionally and preferably communicates with a workload management service 118 in order to provide at least some of the above described characteristics of the data manipulation commands, as well as to provide the necessary resources for performing the job. Optionally and more preferably, workload management service 118 receives information regarding the job submitted (that is the manipulation data commands) and the resources required to execute the job from job management service 116. Workload management service 118 also receives the estimated execution time from prediction engine 110, as well as one or more other characteristics of the data manipulation commands.

Job management service 116 also communicates with data automation services 120, which automatically retrieves data from an external database and provides it for the operation of the job itself.

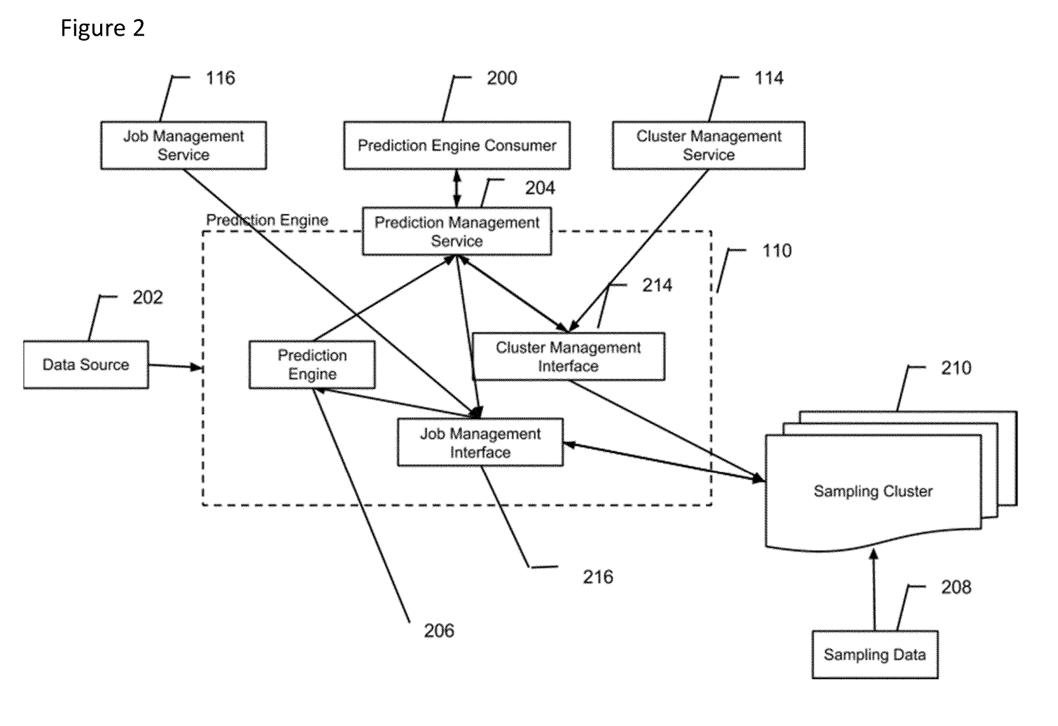

Turning now to FIG. 2, a more detailed description is provided of an exemplary, illustrative, non-limiting implementation of prediction engine 110 according to at least some embodiments of the present invention. As shown, prediction engine 110 is in communication with a prediction engine consumer 200, which is any element within system 100 that may communicate with prediction engine 110. Prediction engine consumer 200 is in communication with a prediction engine management service 204, which may optionally be implemented with prediction engine 110 or alternatively may optionally be implemented with a component that communicates with prediction engine 110, such as job management service 116 for example, as described in FIG. 1. Prediction engine management service 204 may optionally feature any type of protocol translation or other communication services, as necessary.

Prediction engine 110 also optionally is in communication with a data source 202, which provides sample data to prediction engine 110 for performing the necessary analyses for predicting the characteristics of the data manipulation commands.

Once prediction engine 110 receives the necessary sample data (shown as sampling data 208) and also the commands to be performed, prediction engine 110 may optionally and preferably cause the commands to be performed on sampling data 208, through a sampling cluster 210. Sampling cluster 210 is optionally constructed “on the fly” according to the job parameters provided by job management service 116. The construction of sampling cluster 210 preferably reflects the resources to be applied to the actual job itself. For example, if the data infrastructure is based upon Hadoop, then sampling cluster 210 preferably features a Hadoop cluster configuration similar to the configuration on which the job is to be executed. Prediction engine 110 may optionally determine the configuration; additionally or alternatively, the configuration is determined according to input from the user through a user application interface, optionally with one or more external constraints as described in greater detail below.

In order for sampling cluster 210 to be constructed and for a job (set of commands) to be performed on sampling data 208, prediction engine 110 optionally and preferably includes a cluster management interface 214 for communicating with cluster management service 114, and a job management interface 216 for communicating with job management service 116. Both cluster management service 114 and job management service 116 are preferably invoked in order for the test job to be performed on sampling data 208. Cluster management service 114 sets up sampling cluster 210, while job management service 116 handles execution of the job itself, such that sampling cluster 210 receives sample data 208 and then performs the necessary data manipulation commands, to test for the necessary amount of resources and time required to perform the data manipulation commands on the complete set of data.

Prediction engine 110 then performs the necessary analyses on the results of the test job in order to predict the resources and the amount of time required for the complete job. According to the exemplary implementation shown, prediction management service 204 also manages one or more prediction engine analysis modules 206. Prediction engine analysis modules 206 preferably perform the actual prediction analysis, based upon input from job management service 116.

Based on the behavior of the sample data load in sampling cluster 210, prediction engine 110 provides an estimate of the execution time of the job as follows. The sample data and execution of the data manipulation commands is simulated on the Hadoop cluster of sampling cluster 210. Based on some heuristics and learning models, such as the fact that the execution time of a job on a Hadoop cluster is linear according to the size of the dataset, sampling data 208 is sufficient for determination of the estimated execution time of the job on a larger dataset. For data infrastructures which do not have such linear behavior, additional analysis of the dataset and additional correlation of sampling data 208 to the larger dataset may optionally be required.

The learning models preferably incorporate information learned from other executed jobs, including but not limited to any effects caused by the characteristics of the job and of the data. Furthermore, this information also provides heuristics to allow prediction engine 110 to deliver more accurate predictions.

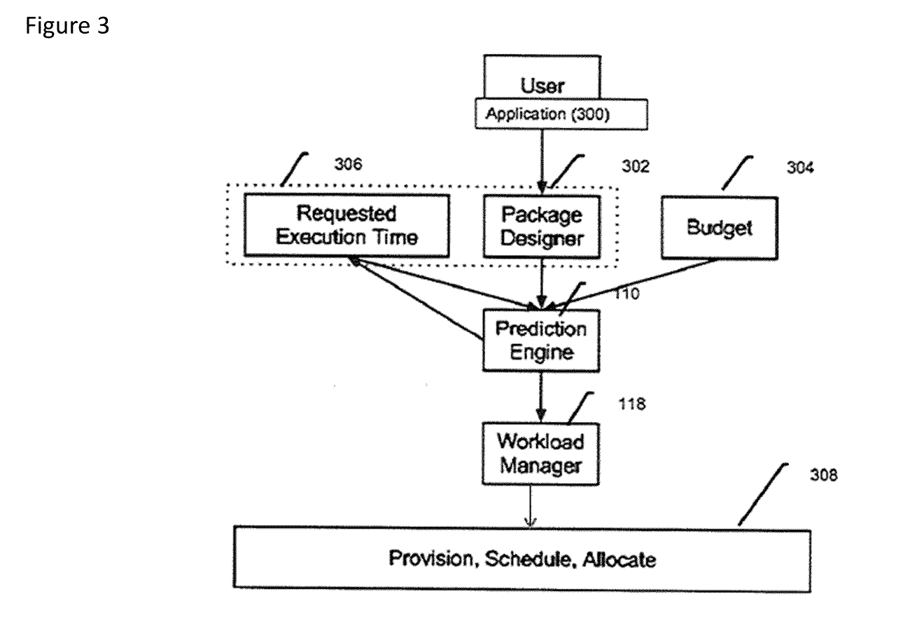

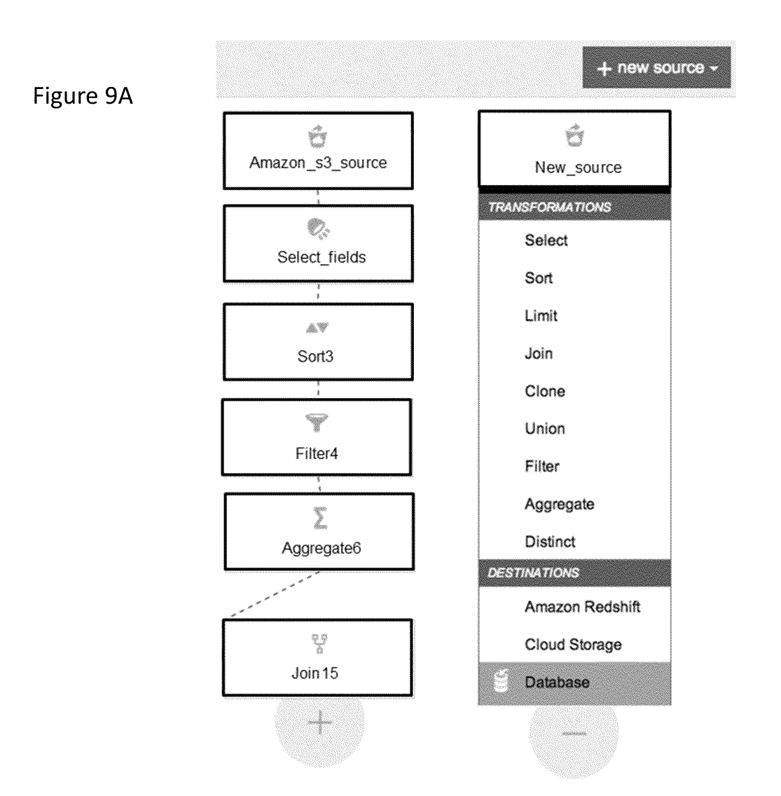

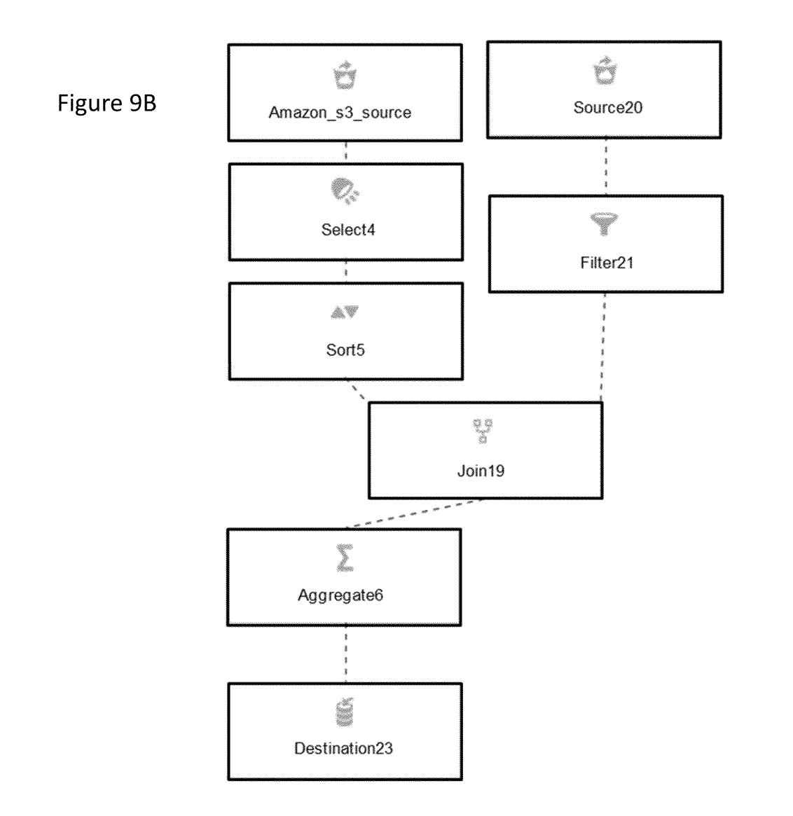

FIG. 3 shows an exemplary, non-limiting flow of operations involving prediction engine 110 according to at least some embodiments of the present invention. As shown, a user application 300 (referred to by a different reference number to indicate that any of the user application interfaces described herein may optionally be implemented) interacts with the user and on the basis of that interaction, provides data manipulation commands and a designation of the data to be manipulated. This information is then provided to a package designer 302, which is optionally and preferably located inside user application 300. Package designer 302 determines how the job should be constructed according to information supplied by the user, with regard to the commands of the job, such that the package includes the job definition, including job parameters, on the definition of the data to be manipulated. Package designer 302 provides a user profile-oriented toolbox menu, screenshots of which are shown in FIG. 9, for enabling the user to design the job (that is, to design the package to be submitted for executing the job). The job parameters are then passed to prediction engine 110.

Optionally the user also requests a specific or bounded execution time through user application 300, which is provided to prediction engine 110 through execution time module 306 as a requested execution time. By “specific execution time” it is meant that the user requests an exact execution time. By “bounded execution time” it is meant that the user requests an upper or maximum execution time.

Prediction engine 110 also preferably receives a budget 304, which may for example optionally be determined according to external factors as described in greater detail below. Budget 304 optionally and preferably includes the amount of system resources which may be devoted to the data manipulation processes, and may also optionally determine the type of system resources which may be applied to these processes. Based upon budget 304 and job parameters from package designer 302, and optionally also upon a requested execution time from execution time module 306, prediction engine 110 determines which system resources should be applied to the job and how long the job will take to execute. As described in greater detail below, prediction engine 110 optionally then provides at least the predicted execution time, and optionally other information about the job, to user application 300 through execution time module 306. The user may then optionally request a change to the job parameters, for example to reduce the execution time, through user application 300, in which case the above process is performed again.

Once the job parameters have been finalized, prediction engine 110 provides these parameters to workload manager 118, which proceeds to provision, schedule and allocate the necessary resources for performing the data manipulations, shown conceptually as module 308.

Optionally the user may choose not to request the job execution time prediction, in which case prediction engine 110 proceeds to communicate directly with workload manager 118.

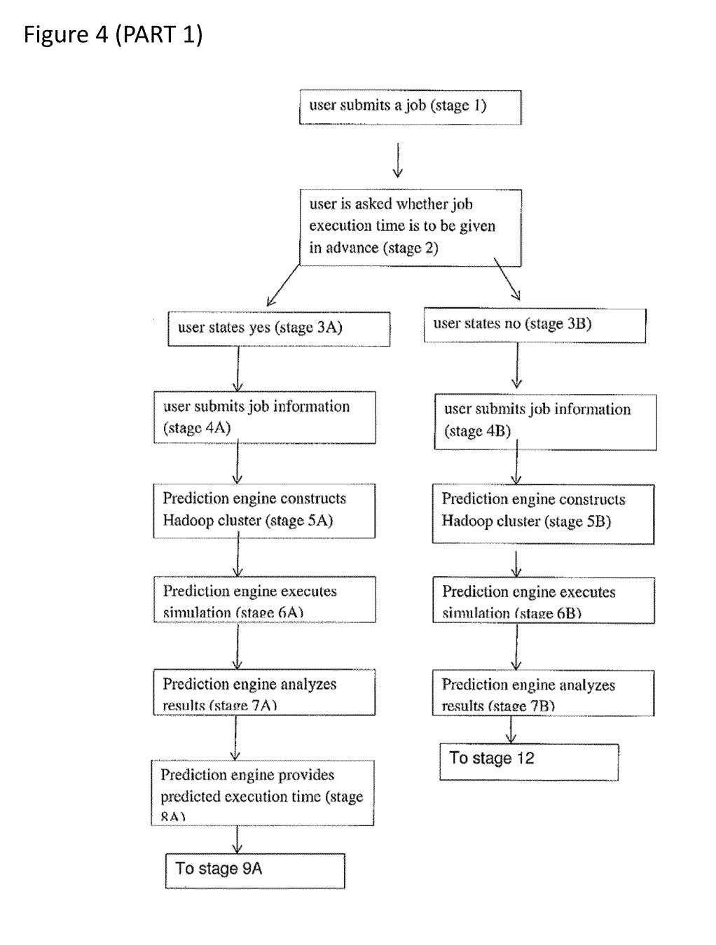

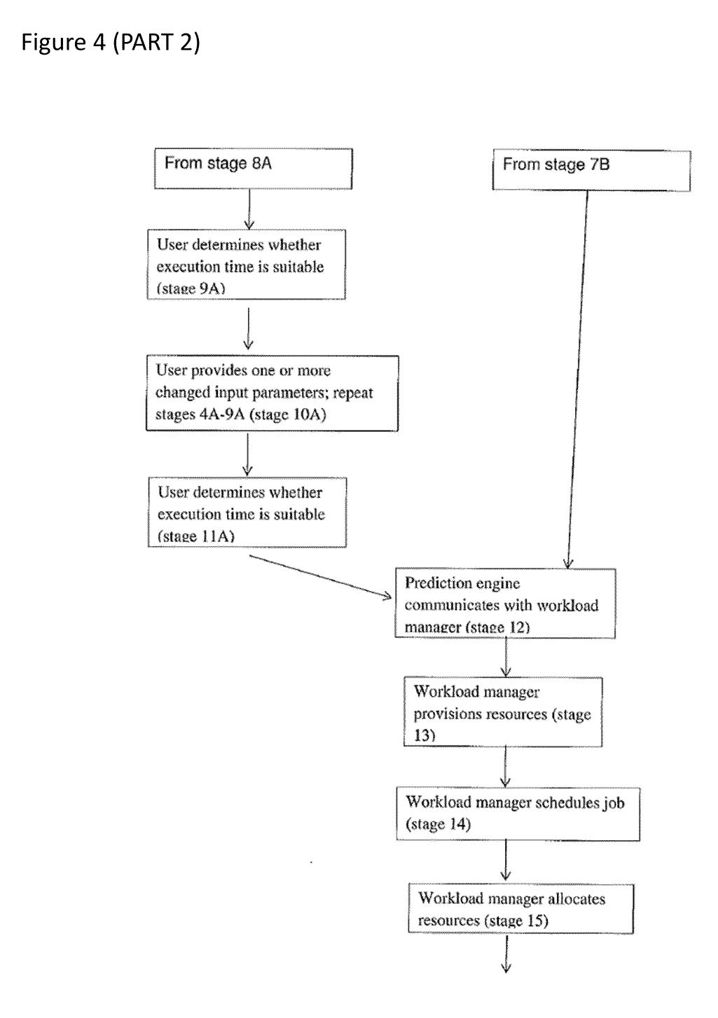

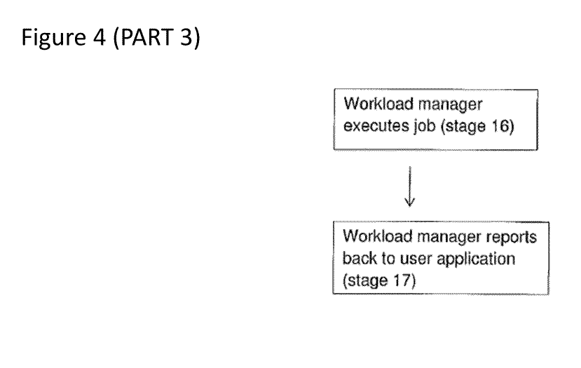

FIG. 4 is a flow chart of an exemplary, illustrative, non-limiting method for interactions between the user, through the user application, and the prediction engine.

As shown, in stage 1, the user submits a job using the previously described user interface application. In stage 2, the user is asked (through the user interface application) whether an estimate of job execution time is to be provided before execution of the job.

If the user does wish to receive such an estimate, then in stage 3A the user interacts with the user interface to indicate that the estimate is to be provided before the job is executed, for example optionally through the user interface. Following along this branch of the method, in stage 4A, the user interface submits the job information to the prediction engine as previously described, with a request for an estimate of the job execution time before execution is performed.

In stage 5A, the prediction engine constructs a Hadoop cluster configuration similar to the configuration the customer intends to execute the job on.

In stage 6A, the prediction engine processes the job as a simulation on the cluster, configured as described above, using a sample of the dataset that will actually be used as an input for the complete job.

In stage 7A, the prediction engine analyzes the results of the simulation to determine a predicted execution time. Optionally and preferably, the prediction engine uses one or more heuristics and/or learning models to do so. For example, as the execution time of a job on a Hadoop cluster is linear according to the size of the dataset, the prediction engine can use the results from the smaller dataset to directly determine an estimated execution time of the job on a larger dataset. For other types of data infrastructures, as previously noted, one or more adjustments to this estimate may optionally be needed, for example optionally to account for the effect of data complexity and/or other characteristics of the dataset, and not just size of the dataset. Also optionally, the prediction engine provides the execution time with boundaries, for example indicating that the execution time is accurate to within a specified number of minutes on either side of the predicted time.

In stage 8A, the prediction engine provides the predicted execution time to the user through the user interface application. In stage 9A, the user determines whether this execution time is suitable, or whether to change one or more parameters in order to obtain a faster execution time. If the latter, then in stage 10A the user provides one or more changed input parameters to the prediction engine and the above steps are repeated.

If the execution time is determined to be suitable, then in stage 11A, the user sends a request to the prediction engine to submit the job for execution to the workload manager.

Turning now to the second branch of the method diagram of FIG. 4, in case the user does not choose to receive an estimate before the operation of the job, then in stage 3B the user indicates that an estimate is not needed in advance through the user interface to the prediction engine. Stages 4B-7B then proceed as for stages 4A to 7A described above. The equivalent to stages 8A-11A is not performed for this branch of the method.

Both branches unite at stage 12, in which the prediction engine sends the job parameters, including the commands, any resources to be used, the data infrastructure configuration (such as the Hadoop cluster configuration for example), the predicted execution time, and any other information to the workload manager.

In stage 13, the workload manager provisions any resources if required. Such provisioning may optionally be required for example to change the cluster configuration for running the job, if the cluster configuration does not already exist, in order to uphold the prediction of the prediction engine. In stage 14, the workload manager schedules the job to run. In stage 15, the workload manager allocates existing resources to the job, such that the configured cluster is actually dedicated to performing the job; optionally the workload manager may need to stop other jobs temporarily or permanently. In stage 16, the workload manager executes the job; as necessary during execution, the workload manager polls the job's status. Upon completion, or optionally also according to some type of status report (such as a problem being encountered during the job), the workload manager reports back to the user interface application, in stage 17.

FIG. 5A shows an exemplary system and FIG. 5B shows an exemplary flow process according to at least some embodiments of the present invention for providing a cluster management service over a Hadoop infrastructure. This process relates to Hadoop for the purpose of illustration only, as any other suitable type of data infrastructure could be used instead. The components of cluster management service are shown as part of the process flow, along with other components that are external to the cluster management service.

As shown in FIG. 5A, a system 500 features a plurality of user computers 502 for receiving one or more user commands in relation to cluster management. Each user computer 502 is in communication with an app server 503 of a system API 504 through a network 506 as previously described; again network 506 may optionally comprise any computer network, but is assumed to relate to the Internet for the purpose of this illustration without wishing to be limited in any way.

API 504 is optionally deployed as a scalable application, such as a Heroku scalable application; however, alternatively, API 504 may optionally be deployed as any PaaS (platform as a service) model. A PAAS platform, also known as a cloud platform, enables the software application to be more easily scaled and executed through a cloud model. Alternatively or additionally, the software application may optionally be provided on a local computing resource accessible to the user through user computer 502, and/or through a remote server (not shown). API 504 is in communication with a plurality of API worker nodes 522 as shown.

System API 504 is in communication with at least CMS (cluster management service) 508 as shown. Upon receiving a request from user computer 502, system API 504, through app server 503, posts a message to a request message queue 510. Request message queue 510 can be accessed CMS 508 as described below. Request message queue 510 may optionally be implemented as an SQS (Amazon Simple Queue Service) queue. Request message queue 510 is part of the cluster management service. SQS is a non-limiting example of a hosted message queue service for web applications.

CMS 508 preferably features a plurality of CMS (cluster management service) worker nodes 514, each of which more preferably operates autonomously for scalability. Each CMS worker node 514 communicates with request message queue 510, preferably regularly polling request message queue 510 for messages. Upon receiving such a message, CMS worker node 514 proceeds to perform the action directed by the message as described in greater detail below, by operating on one or more clusters 518 as shown. Upon completion of the action, CMS worker node 514 returns a message to a response message queue 516, which is then read by API 504. Response message queue 516 is also optionally implemented as an SQS (Amazon Simple Queue Service) queue. Optionally, each of request message queue 510 and response message queue 516 is implemented as a plurality of such queues.

Optionally and preferably, after completing the action, CMS worker node 514 updates a cluster store 520. Cluster store 520 is a database of machine instances and clusters used by CMS 508. The database lists the clusters, the machine and information about them (addresses, configuration instance type—cpu, memory; disk drives, Hadoop distribution, provider, data center, etc.). Cluster store 520 is also read by other parts of the application that need access to the cluster, but it is maintained (optionally strictly or only) by the CMS 508. The machine images are used to enable quick provisioning of a cluster—they already include all the required installations of software, so once cluster provisioning is requested, no software has to be downloaded or installed.

Optionally and preferably, once cluster store 520 is updated, API worker processes 522 receive the updated information and then update a database 524 located at API 504. App server 503 also preferably updates database 524 upon placing a message in request message queue 510. Database 524 therefore includes a record of the requests placed through API 504 and their outcome.

Optionally and preferably, CMS 508 also features a monitoring server 509, which communicates both with request message queue 510 and cloud provider 512. Monitoring server 509 preferably monitors the status of clusters 518 (shown as Hadoop clusters for the sake of illustration only and without any intention of being limiting). For example and without limitation, monitoring server 509 preferably receives various types of information from clusters 518, such as a count of i/o, network and cpu, but also the functionality or “health” of the machine and Hadoop specifics (e.g. missing blocks, number of used and available slots, and so forth). Monitoring server 509 may optionally also include this information in one or more messages to request message queue 510, for example to alert worker nodes 514 to the necessity of performing a repair on a cluster 518.

A number of different processes may optionally be performed with regard to the system of FIG. 5A as described above, a complete list of which is given as follows. Cluster provisioning includes creating new machine instances based on the machine images, configuring them and starting the services. Cluster termination includes shutting down the machine instances and terminating them, releasing all of their resources (storage, ip addresses, etc.). Cluster repair relies on monitoring—when a cluster is broken (for example if a machine is damaged or lost) it is up to the CMS to bring another machine instance up, configure it to join the cluster and make sure that the cluster is operational again. Cluster upgrade involves upgrading the software installed on an existing cluster (patching Hadoop, monitoring services, configuration management services, job-execution supporting software). Cluster scaling—the CMS allows adding or removing machine instances to an existing cluster in order to increase or decrease its compute power.

FIG. 5B below describes the flow for the following tasks: cluster creation, cluster scale, cluster termination. These tasks are selected according to the type of the message and affect (for example) the actions of the CMS worker in stage 6. When the task is cluster creation, the CMS worker uses cloud provider APIs to provision machine instances, it waits for the machine instances to become ready and then configures the cluster, deploys some applications on it and adds it to the monitoring services. When the task is cluster termination, the CMS worker uses cloud provider APIs to terminate the machine instances and removes it from monitoring service. When the task is cluster scaling, the CMS worker uses cloud provider APIs to provision machine instances, configures them and attaches them to an existing cluster (or removes machines from an existing cluster), according to the scale required.

FIG. 5C below describes the flow for cluster repair according to an exemplary non-limiting method thereof.

Turning now to FIG. 5B, in stage 1, a user interacts with the above described user application interface to request a cluster operation (including but not limited to such operations as create, scale, delete) to the API.

The request is then sent to the previously described system API as an API call for cluster creation/scale/deletion as necessary in stage 2. The API controller then optionally creates a cluster “pointer” or indication in its informational database or store in stage 3. This action would be performed for cluster provisioning. For other types of actions, different actions on the database would be performed. When a cluster is repaired, scaled or terminated, the rows are updated appropriately. In stage 4, the API controller posts a request message to a message queue, as previously described. The message could state for example clusters_create for cluster creation, clusters_scale for cluster scale operation or clusters_delete for cluster deletion. With regard to the parameters required for creating a cluster, a clusters_create message preferably contains the number of processing nodes and the total size of the cluster. It will also include the account_id and the cluster_id of the cluster, which are unique within the internal store. These parameters are then used by the CMS workers to provision (create) a cluster automatically.

In stage 5, the CMS (cluster management service) worker nodes poll for messages from the messaging queue and start processing it; as their name suggests, these worker nodes are also part of the cluster management service and they perform the cluster management service worker processes. However, each worker preferably operates independently of the others for scalability. A worker receiving a particular message from the SQS queue preferably processes it synchronously according to the parameters in the message.

In stage 6, the CMS worker process (also described herein as a worker node) creates, scales or deletes a Hadoop cluster according to the processed message, including the previously described parameters. The overall CMS worker node actions preferably include but are not limited to provisioning machine images, provisioning a cluster, terminating a cluster, upgrading a cluster, repairing a cluster and scaling a cluster. In stage 7, the CMS worker process optionally updates the cluster information, for example in the previously described cluster information store.

In stage 8, the worker process optionally posts a response message with progress and status to the response message queue, such as the response SQS queue as described. In stage 9, the API optionally polls for such messages; optionally the API has its own internal workers for handling such messages as previously described.

In stage 10, upon completion of the work determined by the message, the CMS worker process deletes the message from the queue and send a completion message to the relevant messaging queue, which may for example be clusters_create_response for cluster creation response messages, clusters_scale_response for cluster scale operation response messages or clusters_delete_response for cluster deletion response messages.

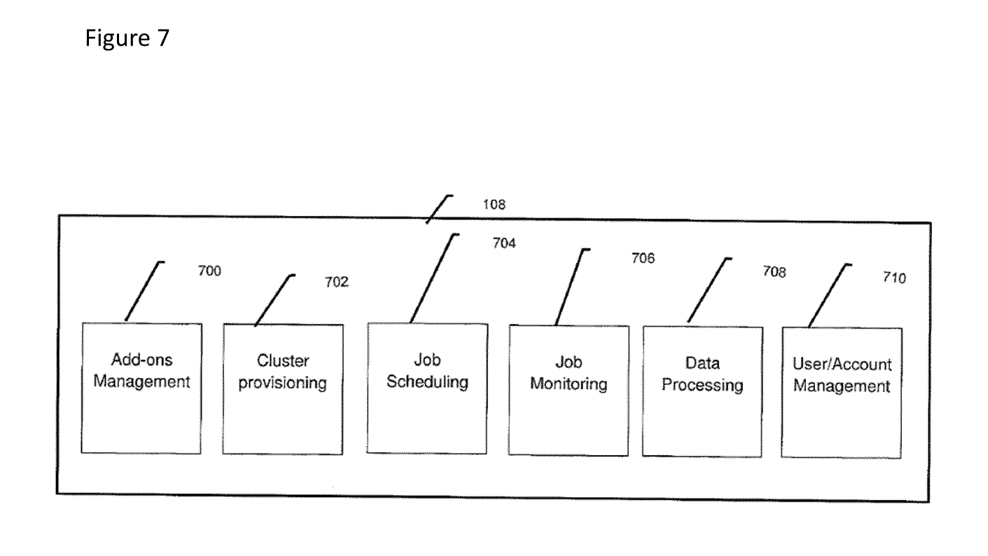

In stage 11, the API polls for messages from the above response message queues and starts processing such messages (see FIG. 7 for a description of the components of the API). In stage 12, the API accesses the cluster information shared store to retrieve the necessary cluster metadata.

FIG. 5C describes the flow for cluster repair according to an exemplary non-limiting method thereof. As shown, in stage 1 the monitoring service detects a failure in a cluster. In stage 2, if the failure relates to a failed node, a repair request message is posted to the message queue as previously described. In stage 3, the CMS worker node processes message. In stage 4, the CMS worker node checks the cluster to determine a difference between the defined number of nodes and the actual number of nodes. In stage 5, the CMS worker node terminates failed nodes if necessary. In stage 6, the CMS worker node uses a cloud provider API to provision new machine instances to replace the failed ones. When the machine instances are ready, they are configured, attached to the cluster, and added to monitoring.

FIGS. 6A-6B show a system and an exemplary flow process according to at least some embodiments of the present invention for providing a job management service over a Hadoop infrastructure. This process relates to Hadoop for the purpose of illustration only, as any other suitable type of data infrastructure could be used instead. The components of the job management service are shown as part of the process flow, along with other components that are external to the job management service.

With regard to the specific operation of JMS 650, FIG. 6A shows JMS 650 in more details. User computer 502 requests to execute job on a cluster; as for FIG. 5A, the request is sent to API 604 and more specifically to app server 603 as shown. API 604 then creates a job record in a database 624. As for FIG. 5A, API 604 (or alternatively API worker nodes 622) posts a request message to a request message queue 610. API 604 (or alternatively API worker nodes 622) builds job information (for example by constructing scripts and/or selecting one or more of functions, parameters or variables) so that the job can be executed.

A JMS worker process or node 612 retrieves the message from message queue 610 and processes the message. JMS worker process 612 then submits job directly to a coordinator manager, shown as an oozie server 660 for the purpose of illustration only and without wishing to be limiting in any way; for example, an Azkaban server could be used instead. Regardless of the exact service used, server 660 is located at cloud provider 512, while providing information about the specified cluster with the job information. Oozie server 660 optionally updates JMS worker process 612 periodically although optionally an alternative service is used as described below. Optionally, such updating by oozie server 660 occurs as follows. JMS worker process 612 periodically retrieves job information including status (stopped/failed/completed) from oozie server 660.

JMS worker process 612 at least posts a response message to a response message queue 614 upon completion of the job, but preferably also posts periodic updates as received from oozie server 660 or alternatively from a JNMS 620 as described below.

API worker process 622 polls response message queue 614 periodically and updates API database 624. The executed job throws progress notifications with callback to a JNMS (job notification management service) 620 which directly monitors the process on a cluster 618, preferably without interactions with oozie server 660. At least upon completion of the job, or alternatively and optionally periodically, JNMS 620 posts response message to response message queue 614. Upon completion, JNMS 620 posts a final response message to response message queue 614.

Again, optionally periodically, API worker process 622 polls response message queue 614 and updates API database 624.

Turning now to FIG. 6B, which shows an exemplary job management service method according to at least some embodiments of the present invention, as shown, in stage 1, a user interacts with the above described user application interface to request a job operation (including but not limited to such operations as execute a job or kill a job) to the API. The API is optionally deployed as previously described. Alternatively or additionally, the software application may optionally be provided on a local computing resource accessible to the user, and/or through a remote server.

The request is then sent to the previously described system API in stage 2, which builds the job (for example by constructing scripts, and determining one or more of functions, parameters and variables). The API then posts a request message to a message queue, such as an SQS (Amazon Simple Queue Service) queue in stage 3. The message queue is part of the cluster management service. SQS is a non-limiting example of a hosted message queue service for web applications. In stage 4, the JMS (job management service) worker nodes (or processes) poll for messages from the SQS queue and start processing it; as their name suggests, these worker nodes are also part of the job management service and they perform the job management service worker processes.

In stage 5, the JMS worker process generates a workflow with the specified job for the coordinator manager, which is another part of the job management service. The JMS worker process then submits the job for execution to the coordinator manager. A non-limiting example of a coordinator manager is an Oozie server, which is used in conjunction with Hadoop to run jobs on Hadoop clusters. Typically but not necessarily, the data infrastructure provides the coordinator manager.

In stage 6, the coordinator manager receives the job submission and executes it on the specified cluster, according to the received workflow. In stage 7, the JMS worker process polls and optionally and preferably continues to poll the coordinator manager for job updates; the worker process then posts a response message with the progress and status information to the response SQS queue. In stage 8, the API polls for messages from the response message queue (see FIG. 7 for a description of the components of the API) and processes such messages.

FIG. 7 shows an exemplary, schematic block logic diagram for the API according to at least some embodiments of the present invention. As shown, API 108 optionally and preferably features an add-on management module for communicating with add-on management service 112, and for managing add-on management service 112. API 108 also preferably features a cluster provisioning module 702 for communicating with cluster management service 114 and for controlling the provisioning of clusters of the data infrastructure (not shown). API 108 also preferably features a job scheduling module 704, for scheduling jobs, and a job monitoring module 706 for monitoring these jobs, both of which communicate with job management service 116.

In addition, API 108 preferably features a data processing module 708 which manages the interactions with the data infrastructure. API 108 also preferably features user and account management module 710, which communicates with the user interface application (not shown) but which also manages and controls the various actions of the user, for example as described with regard to the package designer below.

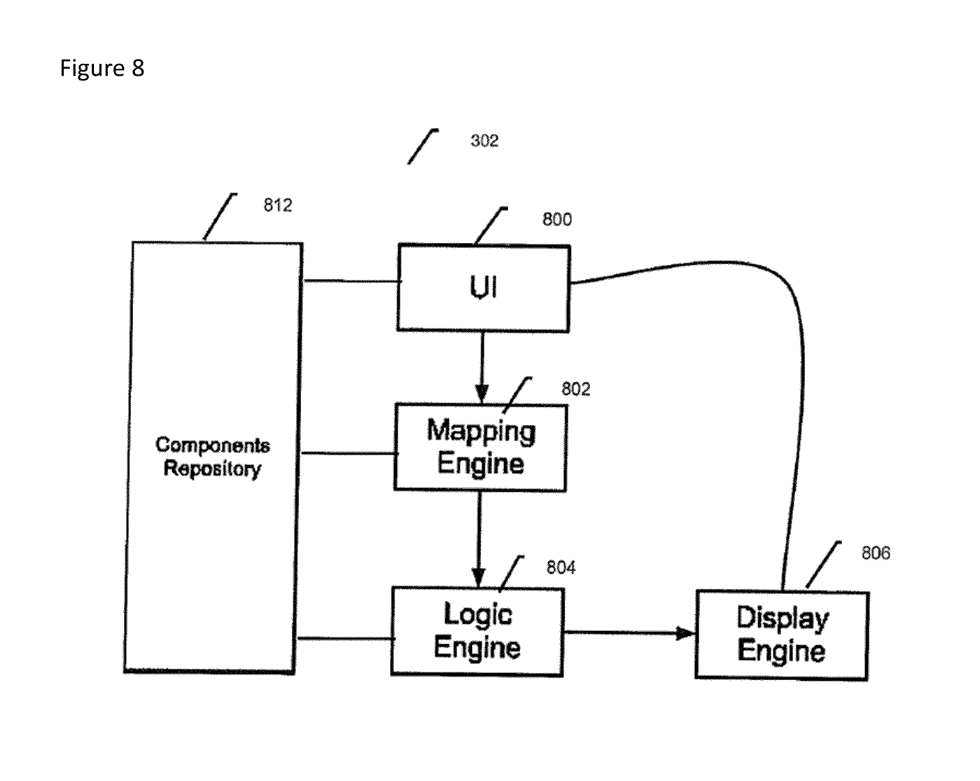

FIG. 8 shows an exemplary, non-limiting, illustrative schematic block logic diagram for the package designer in greater detail according to at least some embodiments of the present invention. Package designer 302 provides a user profile-oriented menu, screenshots of which are shown in FIG. 9, for enabling the user to design the job (that is, to design the package to be submitted for executing the job). The user uses a “drawing board”/“design canvas”, provided through the user interface application (not shown), to design a data pipeline. The user selects from various displayed commands to construct the package, as described below. These commands are also described as components, as they are preferably displayed as individual modules to the user through the user interface application on the design canvas. Optionally and preferably, these components are displayed in such a manner that the user is able to construct the set of commands for data manipulation without having to write code and more preferably without having to understand how to use and manipulate Hadoop commands and structures.

As shown, package designer 302 preferably includes a components repository 812 for containing these components and a UI engine 800 for communicating with the user interface application (not shown). When a user chooses a specific component through the user interface application, UI engine 800 sends the component specifications and parameters, obtained from components repository 812, to a mapping engine 802. Mapping engine 802 contains the list of available components that the specified component can connect to, by retrieving the necessary component information from components repository 812. Mapping engine 802 is optionally and preferably provided with such components according to the capabilities of the data infrastructure (not shown), since for example and without limitation, the data infrastructure may only be able to execute some commands after other commands are performed, or vice versa. Furthermore, in certain contexts, certain commands may not be possible at all, due to the limitations or requirements of the data infrastructure.

Mapping engine 802 sends the list of available mapped components to a logic engine 804, which analyses them and based on the parameters determines which components are permitted to the user at that exact time and configuration of the components on the design canvas, for example based upon the user's profile, permissions, amount and/or type of computational and/or database resources which the user is permitted to consume, other types of business rules and so forth. Logic engine 804 may also optionally, additionally or alternatively to mapping engine 802, select such components based on functionality (for example, a “destination” component cannot be followed by a “source” component”). Logic engine 804 retrieves the component details from components repository 812.

The list of permitted components is sent from logic engine 804 to a display engine 806. Display engine 806 preferably performs any rendering and then sends the list of available components that are allowed to be displayed to UI engine 800, which sends the rendered components to the user interface application.

Optionally, the user accesses these rendered components as follows. Shown visually on the design canvas, under every component that's not a terminating component (i.e. destination), a “button” or other GUI gadget is displayed which can be either clicked or dragged. When clicked, a components list is opened and by clicking the name of component, the new component is created on the canvas and is linked to the previous component. In addition, the GUI gadget itself may optionally be dragged and dropped on an existing component that doesn't have a preceding component connected to it.

Some exemplary, illustrative non-limiting screenshots of the design canvas as it could appear to the user through the user interface application are shown in FIGS. 9A and 9B. As shown in FIG. 9A, the canvas displays data manipulation components as separate boxes; a drop down menu on the right hand side provides some choices to the user for selecting an additional command to perform on a data source. FIG. 9B shows an exemplary final string of data commands.

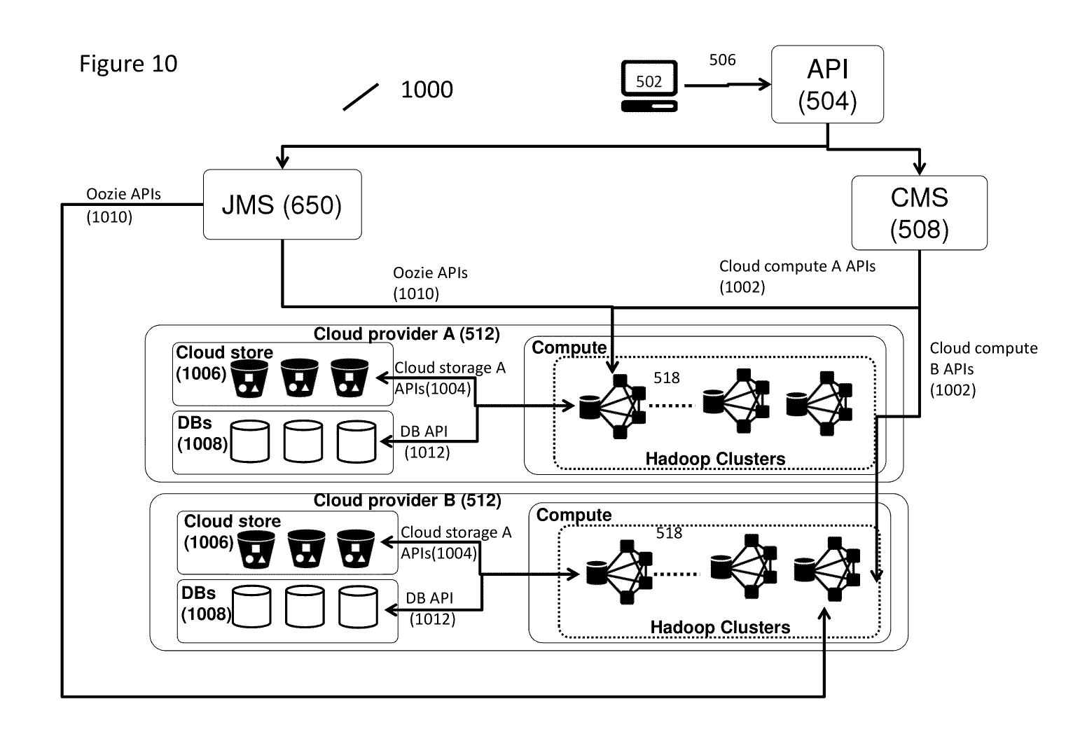

FIG. 10 relates to an exemplary, illustrative non-limiting system according to at least some embodiments of the present invention for cluster provision and management across a plurality of cloud providers, which may optionally be defined as any provider of IAAS (infrastructure as a service), by providing compute and storage functions by means of virtual machine instances and storage in the form of object stores and block storage. The previous examples assumed that Hadoop clusters could be provisioned and managed on a cloud provider, of which the non-limiting example was Amazon Web Services (AWS) without specifying the possibility of provisioning and managing across multiple and/or different providers. Again without wishing to be limited to a closed list, the present invention may optionally be implemented on any cloud provider, including but not limited to AWS, AT&T Silver Lining, Rackspace Cloud, Softlayer, Google Cloud, Microsoft Azure, Joyent or CloudSigma. It should be noted that the below method for provisioning and management across a plurality of cloud providers may optionally be used for provisioning and management across multiple data centers or regions within a provider and/or different Hadoop distributions as previously described.

The overall system 1000 as shown in FIG. 10 also features the previously described system of FIGS. 5A and 6A, but with a plurality of cloud providers 512, shown as cloud providers A and B for the purpose of illustration only and without any intention of being limiting. Components with the same numbers have the same or similar function as for these drawings. In order to support the different cloud providers 512, preferably a plurality of APIs 1002 are provided, each in communication with a different cloud provider 512. Each API 1002 may optionally feature different functionality. For example, on Silver Lining, Rackspace and Softlayer DNS services, firewalls, and so forth are preferably provided through API 1002, but these services are not required for AWS.

In operation, CMS 508 contacts clusters 518 of each cloud provider 512 through API 1002 according to the request messages as previously described. JMS 650 in turn contacts clusters 518 through an Oozie API 1010 (or some other type of API, according to the server being contacted; the Oozie server itself is not shown). Each Oozie API 1010 is preferably adapted to the functionality required for the particular cloud server 512 which is contacted.

As shown, cloud provider 512 now further features a cloud store 1006 and a cloud database 1008, each of which features its own API to communicate with clusters 518, shown as cloud storage API 1004 and DB (database) API 1012, respectively.

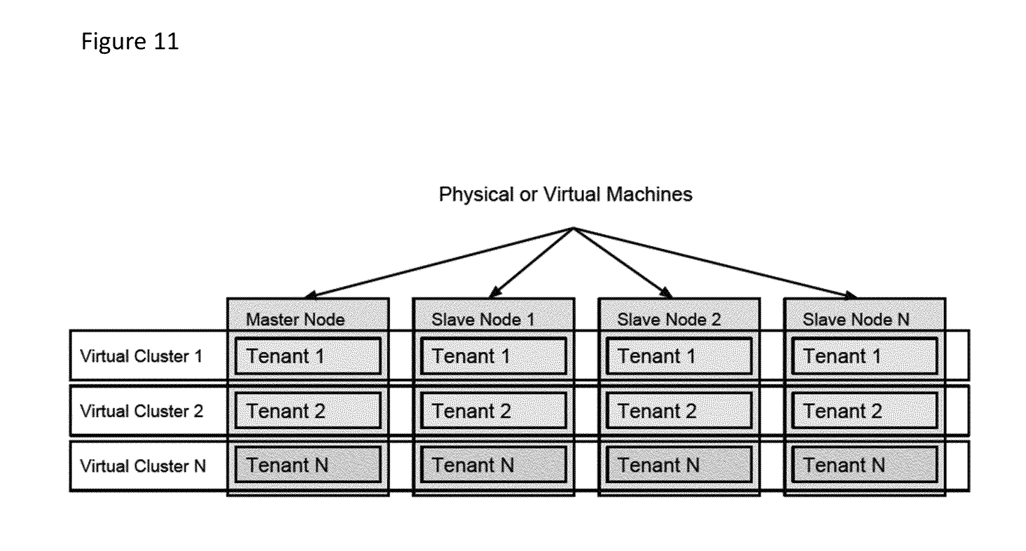

FIG. 11 shows an exemplary illustrative multi-tenancy architecture system according to at least some embodiments of the present invention. Multi-tenancy architecture allows the system to run multiple Hadoop clusters on top of the same hosts (machines), so that each of the clusters serves a different tenant with complete isolation from the other tenants in terms of security (so that data and data processing tasks are completely secured on the cluster) and resource management (so that a tenant isn't starved of resources).

As shown, a system 1100 features a plurality of machines 1102, which may be physical or virtual. Machines 1102 include a master node 1104 and a plurality of slave nodes 1106. Each machine 1102 features a plurality of tenants 1108, shown as tenant 1, tenant 2, tenant 3 and so forth. Master node 1104 controls each tenant 1108 on all slave nodes 1106, such that each tenant 1108 has its own virtual cluster 1110.

To keep the data and processes separate for each tenant 1108, operating system-level virtualization is used to isolate the different services from one another on each machine 1102. Operating system-level virtualization is available from, or can be supported by, software architecture from various sources, such as the Docker system (https://www.docker.io/) or Linux Containers (http://lxc.sourceforge.net/). The multi tenancy layer (master node 1104) manages clusters of machines and processes on them using, for example, Linux containers. The multi tenancy layer is aware of available and used resources and is able to allocate and isolate resources (cpu, memory, network, storage quota) for Hadoop processes (or other processes).

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination. It will also be appreciated by persons skilled in the art that the present invention is not limited by what has been particularly shown and described hereinabove.

Although the invention has been described in conjunction with specific embodiments thereof, it is evident that many alternatives, modifications and variations will be apparent to those skilled in the art. Accordingly, it is intended to additionally embrace all such alternatives, modifications and variations that fall within the spirit and broad scope of the appended claims.

What is claimed is:

1. A method for predicting at least one of execution time or execution resources required for executing a data job, the data job comprising at least one data manipulation command on a data set, the method being performed by a computer, the method comprising:
Providing a data cluster for executing the data job, said data cluster comprising computer hardware and a data infrastructure for performing said at least one data manipulation command with said computer hardware;
Extracting sample data from the data set;
Constructing a sample data cluster according to said sample data and said at least one data manipulation command;
Executing said at least one data manipulation command on said sample data with said sample data cluster;
Analyzing execution time required for executing said at least one data manipulation command on said sample data; and
Determining at least one of execution time or execution resources required for executing the data job according to said execution time for said sample data.

2. The method of claim 1, further comprising receiving the data job through a user interface application and for communicating said at least one of execution time or execution resources required for executing the data job to said user interface application.

3. The method of claim 2, further comprising requesting a change in execution resources to be applied to the data job through said user interface application; reconstructing said sample data cluster; re-executing said at least one data manipulation command on said sample data; analyzing said new execution time; determining at least one of a new execution time or new execution resources required; and communicating said at least one of execution time or execution resources required for executing the data job to said user interface application.

4. The method of claim 3, further comprising obtaining the data job by: providing a job design canvas through said user interface application; and determining a plurality of data manipulation commands and the data set through said job design canvas.

5. The method of claim 4, wherein said determining said plurality of data manipulation commands further comprises: selecting a plurality of choices of data manipulation commands from a components repository according to at least one functional constraint and according to at least one user profile constraint; and displaying said plurality of choices of data manipulation through said job design canvas.

6. The method of claim 5, wherein said at least one user profile constraint is determined according to permitted resources determined by a user profile.

7. The method of claim 6, wherein said at least one functional constraint is determined according to said data infrastructure.

8. The method of claim 7, wherein said selecting said choices and displaying said choices are sufficient to construct a set of commands for data manipulation, without the user writing code.

9. The method of claim 8, wherein said selecting said plurality of choices further comprises only displaying choices of commands that are possible to execute within constraints of said data infrastructure.

10. The method of claim 9, further comprising a logic engine, wherein said logic engine determines which choices of commands are permissible to display.

11. The method of claim 10, further comprising providing an add-on management service for providing at least one additional resource for executing the job.

12. The method of claim 11, further comprising establishing compensation for said at least one additional resource through said user interface application, wherein said at least one additional resource comprises at least one of a changed data cluster or an additional data set.

13. The method of claim 12, wherein said data infrastructure comprises Hadoop.

14. The method of claim 13, further comprising sending a command to execute the job through said user interface; transmitting a message to a cluster management service to initiate allocation of one or more clusters to the job; allocating said one or more clusters by said cluster management service; transmitting a message to a job management service to build job information for executing the job; building said job information by said job management service; and executing the job on said one or more clusters.

15. The method of claim 14, further comprising monitoring execution of the job by said job management service.

16. The method of claim 15, wherein said one or more clusters are provided by one of a plurality of cloud providers, the method further comprising: selecting a cloud provider for providing said one or more clusters according to one or both of said execution resources and said execution time.

17. A system for predicting at least one of execution time or execution resources required for executing a data job, the data job comprising at least one data manipulation command on a data set, the system comprising:
A data cluster for executing the data job, said data cluster comprising computer hardware and a data infrastructure for performing said at least one data manipulation command with said computer hardware;
A cluster management service for constructing a sample data cluster; and
A prediction engine for extracting sample data from the data set, for causing said at least one data manipulation command to be executed on said sample data with said sample data cluster, for analyzing execution time required for executing said at least one data manipulation command on said sample data and for predicting at least one of execution time or execution resources required for executing the data job according to said execution time for said sample data.

18. The system of claim 17, further comprising a job management service for managing execution of the job on said data cluster according to said data infrastructure, and for managing execution of said at least one data manipulation command to be executed on said sample data with said sample data cluster.

19. The system of claim 18, further comprising a user interface application for communicating with a user, said user interface application receiving parameters of the job and transmitting said parameters to said prediction engine.

20. The system of claim 19, wherein said user interface application receives said at least one of execution time or execution resources required from said prediction engine and requests additional execution resources from said prediction engine.
